(19) United States
(12) Patent Application Publication
(10) Pub. No.: US 2013/0032099 A1
(43) Pub. Date: Feb. 7, 2013

(54) FRICTIONAL FLUID HEATING DEVICE AND METHOD THEREOF

(71) Applicant: Chi-Hyun Han, Daejeon Metropolitan (KR)

(72) Inventor: Chi-Hyun Han, Daejeon Metropolitan (KR)

(21) Appl. No.: 13/198,670

(22) Filed: Aug. 4, 2011

(51) Int. Cl. F03B 13/00; F15D 1/00

(52) U.S. Cl. 122/26; 137/1

(57) ABSTRACT

A frictional fluid heating device and a method relating thereto. The device comprises a shaft fixed part, a drive shaft that is supported by the shaft fixed part to be rotatable about an axis of rotation thereof, a disc assembly, and a frame assembly. The disc assembly comprises a plurality of first-type discs, each of which comprises a front surface, a rear surface, a peripheral surface, and an impeller for facilitating fluid flow in the device. An elevated portion is located on the front surface of each of the first-type discs around the opening of the disc. The elevated portion has a peripheral surface, and the impeller is mounted on the peripheral surface of the elevated portion. The impeller comprises grooves and gear tops that are substantially diagonally formed and are alternately located on the circumference of the impeller.

### BACKGROUND OF THE INVENTION

1. Field of the Invention

The invention herein relates to a device for heating fluid through friction and a method relating thereto.

2. Background Information

It has been known that water or similar fluid may be heated through friction, and a number of devices that apply or attempt to apply the concept have been also known. Such devices generally utilize one or more rotors that are installed in a heating chamber of the device to be rotatable therein by a power provided by a conventional power source. A device in the art that is typically constructed to provide desirably large amount of output fluid in a prescribed time tends to produce output fluid that is not heated enough. On the contrary, a device in the art that might be constructed to generate enough friction to sufficiently heat fluid tends to be impractical due to low fluid output/exiting rate.

### SUMMARY OF THE INVENTION

A frictional fluid heating device of an embodiment of the present invention generally comprises a shaft fixed part, a drive shaft that is supported by the shaft fixed part to be rotatable about an axis of rotation thereof, a disc assembly, and a frame assembly. In an embodiment, the disc assembly comprises a plurality of first-type discs, each of which comprises a front surface, a rear surface, a peripheral surface, and an impeller. An opening is formed at a central portion of each of the first-type discs to receive the drive shaft. An elevated portion is located on the front surface of each of the first-type discs around the opening of the disc. The elevated portion has a peripheral surface, and the impeller is mounted on the peripheral surface of the elevated portion. The impeller comprises grooves and gear tops that are substantially diagonally formed and are alternately located on the circumference of the impeller. A plurality of recesses are formed on the front surface of each of the first-type discs along a peripheral edge of the front surface of the disc, and a plurality of recesses are formed on the rear surface of each of the first-type discs along a peripheral edge of the rear surface of the disc. The frame assembly comprises a rear frame, an intermediate frame, and a front frame such that the rear frame, the intermediate frame, and the front frame are combined together. The frame assembly is attached to the shaft fixed part. A through hole is formed in the rear frame to receive fluid in. An opening is formed at a central portion of the rear frame to receive the drive shaft. The frame assembly forms a chamber defined by an internal surface of the frame assembly. The disc assembly is located within the chamber such that there is a gap formed between the internal surface of the frame assembly and an outer surface of the disc assembly to allow fluid to flow therethrough. The first-type discs are coaxially mounted on the drive shaft so as to be rotatable together with the drive shaft. A through hole is formed in the front frame to allow fluid to flow out therethrough. A plurality of recesses are formed on the internal surface of the frame assembly such that the recesses on the first-type discs face in a passing manner the recesses of the frame assembly when the first-type discs are rotated together with the drive shaft.

In another embodiment, the disc assembly may further comprise a second-type disc. The second-type disc comprises a front surface, a rear surface, and a peripheral surface. A plurality of recesses are formed on the front surface of the second-type disc along a peripheral edge of the front surface of the second-type disc, and a plurality of recesses are formed on the rear surface of the second-type disc along a peripheral edge of the rear surface of the second-type disc. The first-type discs and the second-type disc are coaxially mounted on the drive shaft so as to be rotatable together with the drive shaft.

A method of facilitating fluid flow in a frictional fluid heating device of an embodiment of the present invention generally comprises: providing a disc comprising an elevated portion, wherein the elevated portion comprises a peripheral surface; providing an impeller mounted on the peripheral surface of the elevated portion, wherein the impeller comprises grooves and gear tops that are substantially diagonally formed and are alternately located on the circumference of the impeller; and locating the disc with the impeller mounted thereon in a fluid-heating chamber of the frictional fluid heating device such that the disc with the impeller mounted thereon is rotatable together with a drive shaft.

### BRIEF DESCRIPTION OF THE DRAWINGS

FIG. 1 is a cross-sectional view of an embodiment of the present invention, which is taken along an axis of rotation, showing that structural elements thereof are assembled.

FIG. 2 illustrates structural elements of an embodiment of the present invention that are dissembled.

FIG. 3 is a front view of a rear frame of the embodiment shown in FIG. 1.

FIG. 4 is a front view of a rear disc of the embodiment shown in FIG. 1 before an impeller is mounted on the rear disc.

FIG. 4-1 is a front view of an impeller to be mounted on the rear disc shown in FIG. 4.

FIG. 5 is a front view of a first intermediate frame part of an intermediate frame of the embodiment shown in FIG. 1.

FIG. 6 is a front view of an intermediate disc of the embodiment shown in FIG. 1 before an impeller is mounted on the intermediate disc.

FIG. 6-1 is a front view of an impeller to be mounted on the intermediate disc shown in FIG. 6.

FIG. 7 is a front view of a second intermediate frame part of the intermediate frame of the embodiment shown in FIG. 1.

FIG. 8 is a front view of an embodiment of a front disc.

FIG. 9 is a front view of a front frame of the embodiment shown in FIG. 1.

FIG. 10 illustrates arrangement of a plurality of recesses of a disc relative to arrangement of a plurality of recesses of a frame in an embodiment of the present invention, wherein the disc and the frame directly face each other.

FIG. 11 illustrates an impeller of the rear disc or of the intermediate disc of the embodiment shown in FIG. 1.

### DETAILED DESCRIPTION OF THE INVENTION

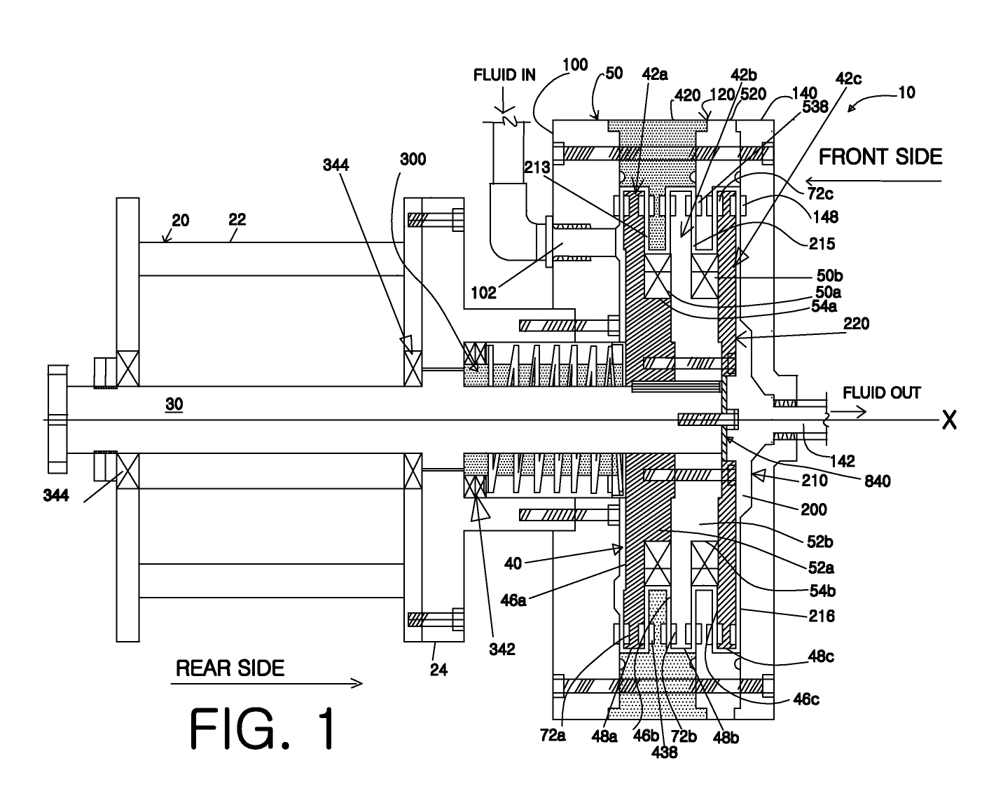

FIG. 1 illustrates an embodiment of a frictional fluid heating device and a method of facilitating fluid flow therein of the present invention. A frictional fluid heating device 10 comprises a shaft fixed part 20, a drive shaft 30 that is supported by the shaft fixed part 20 to be rotatable about an axis of rotation X thereof, a disc assembly 40, and a frame assembly 50. In an embodiment, the disc assembly 40 comprises a plurality of first-type discs 42a, 42b, each of which comprises a front surface 44a or 44b, a rear surface 46a or 46b, a peripheral surface 48a or 48b, and an impeller 50a or 50b. An opening 60a or 60b is formed at a central portion of each of the first-type discs 42a, 42b to receive the drive shaft 30. An elevated portion 52a or 52b is located on the front surface of each of the first-type discs 42a, 42b around the opening 60a or 60b of the disc. The elevated portion 52a or 52b has a peripheral surface 54a or 54b, and the impeller 50a or 50b is mounted on the peripheral surface 54a or 54b of the elevated portion 52a or 52b to facilitate fluid flow in the device.

FIG. 11 illustrates an embodiment of the impeller 50a or 50b. The impeller 50a or 50b comprises grooves 56 and gear tops 810 that are substantially diagonally formed and are alternately located on the circumference of the impeller 50a or 50b. The substantially diagonally-formed grooves 56 of the impeller 50a or 50b may be substantially uniformly spaced apart and the substantially diagonally-formed gear tops 810 of the impeller 50a or 50b may be substantially uniformly spaced apart such that the arrangement of the grooves 56 and gear tops 810 of the impeller 50a or 50b is similar to an arrangement of grooves and gear tops of a helical gear. In an embodiment, an angle A between each gear top 810 of the impeller 50a or 50b and the axis of rotation X is approximately 45° to approximately 50°, as illustrated in FIG. 11. In the embodiment shown in FIG. 11, each of the grooves 56 and gear tops 810 is diagonally disposed from rear left to front right direction. In such arrangement of the grooves 56 and gear tops 810, the impeller 50a or 50b may be rotated counterclockwise (when the impeller 50a or 50b is viewed from the front) together with the drive shaft 30 to pull fluid in to a next path, thereby facilitating fluid flow in the device 10. In another embodiment, the impeller 50a or 50b may be rotated clockwise (when the impeller is viewed from the front) together with the drive shaft 30. However, in such case fluid output rate (amount of fluid exiting through the through hole 142 per certain time) is smaller than in the case where the impeller is rotated counterclockwise. In still another embodiment, each of the grooves and gear tops of the impeller may be diagonally disposed from rear right to front left direction. In such arrangement of the grooves and gear tops, the impeller may be rotated either clockwise or counterclockwise.

As illustrated in FIGS. 4 and 6, a plurality of recesses 70a or 70b are formed on the front surface 44a or 44b of each of the first-type discs 42a, 42b along a peripheral edge of the front surface of the disc. Similarly, a plurality of recesses 72a or 72b are formed on the rear surface 46a or 46b of each of the first-type discs 42a, 42b along a peripheral edge of the rear surface of the disc.

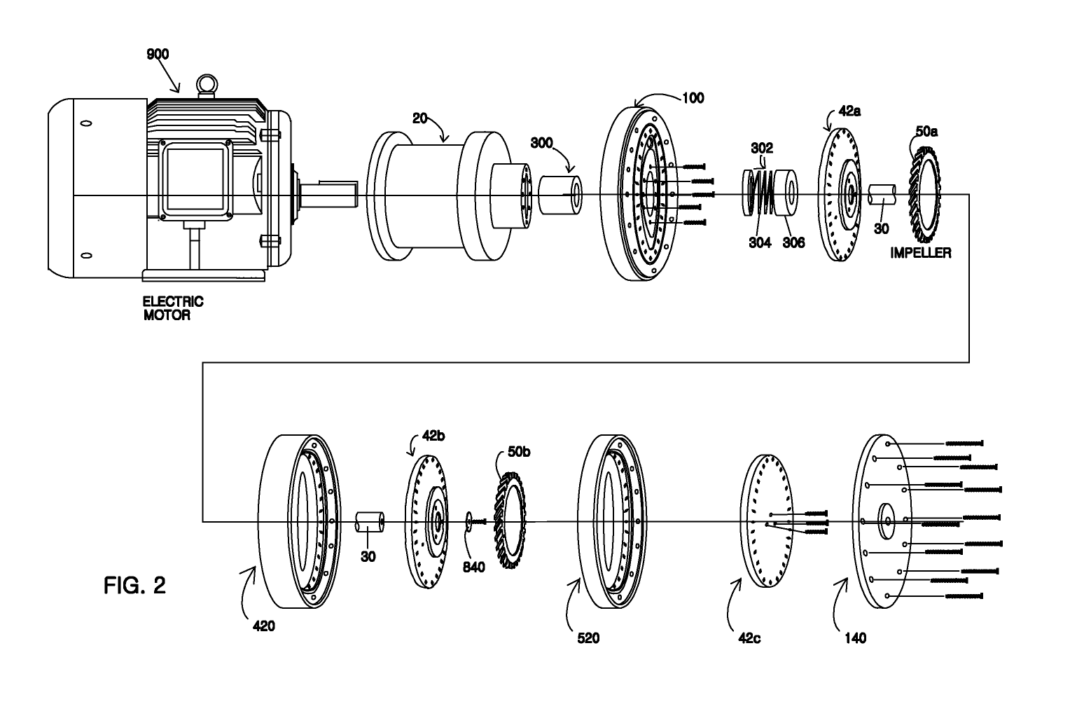

The frame assembly 50 comprises a rear frame 100, an intermediate frame 120, and a front frame 140 such that the rear frame 100, the intermediate frame 120, and the front frame 140 are combined together by fastening means such as screw bolts. The frame assembly 50 is attached to the shaft fixed part 20 so that the frame assembly 50 and the shaft fixed part 20 are stationary whereas the disc assembly 40 is rotatable together with the drive shaft 30. The frame assembly 50 may be attached to the shaft fixed part 20 by bolting the rear frame 100 and the shaft fixed part together as shown in FIGS. 1 and 2. A through hole 102 is formed in the rear frame 100 to receive fluid such as water in. An opening 104 is formed at a central portion of the rear frame 100 to receive the drive shaft 30. The frame assembly 50 forms a chamber 200 defined by an internal surface 210 of the frame assembly 50. The disc assembly 40 is located within the chamber 200 such that there is a gap formed between the internal surface 210 of the frame assembly 50 and an outer surface 220 of the disc assembly 40 to allow fluid to flow therethrough. The first-type discs 42a, 42b are coaxially mounted on the drive shaft 30 so as to be rotatable together with the drive shaft 30. A through hole 142 is formed in the front frame 140 to allow fluid to flow out therethrough. A plurality of recesses 108, 428, 438, 538 are formed on the internal surface 210 of the frame assembly 50 such that the recesses 70a, 72a, 70b, 72b on the first-type discs 42a, 42b face in a passing manner the recesses 438, 108, 538, 428 of the frame assembly 50 when the first-type discs 42a, 42b are rotated together with the drive shaft 30.

The shaft fixed part 20 comprises a main body 22 and a front part 24 that are combined together by bolting or welding. An opening is formed throughout the main body 22 and the front part 24 of the shaft fixed part 20 so as to receive the drive shaft 30. The drive shaft 30 is surrounded by a bore bearing 344 in the main body 22 of the shaft fixed part 20 such that the bore bearing 344 is located between the drive shaft 30 and the main body 22 of the shaft fixed part 20. The bore bearing 344 may rotate together with the drive shaft 30 when the drive shaft 30 rotates. The bore bearing 344 may be made of steel or stainless steel. The drive shaft 30 is surrounded by a sleeve 300 in the opening of the front part 24 of the shaft fixed part 20 and continuously in the opening 104 of the rear frame 100, as illustrated in FIG. 1. When the device 10 is assembled, the rear frame 100 and the front part 24 of the shaft fixed part 20 are connected to each other such that the opening of the front part 24 of the shaft fixed part 20 and the opening 104 of the rear frame 100 provide one continuous opening. The sleeve 300 mounted on the drive shaft 30 prevents the disc assembly 40 from coming too close to the frame assembly 50 by maintaining the distance between the disc assembly 40 and the frame assembly 50. Due to the presence of the sleeve 300, the disc assembly 40 does not collide with the frame assembly 50 while the disc assembly 40 rotates together with the drive shaft 30. The sleeve 300 can rotate together with the drive shaft 30 when the drive shaft 30 rotates. In another embodiment, the sleeve 300 may be stationary while the drive shaft 30 rotates.

As illustrated in FIG. 1, a ceramic bearing 342 is mounted on and around a rear portion of the sleeve 300 to seal an inner/rear opening space formed between the rear portion of the sleeve 300 and the shaft fixed part 20 so that any fluid entering into the opening of the front part 24 of the shaft fixed part 20 cannot go any further rearwardly. The ceramic bearing 342 may rotate with the sleeve 300 if the sleeve 300 rotates together with the drive shaft 30. In another embodiment, the ceramic bearing 342 may not rotate at any time if the sleeve 300 is stationary while the drive shaft 30 rotates. The ceramic bearing 342 is made of ceramic to be resistant to abrasion.

An elastic member 302 is also mounted on and around the sleeve 300 next to the ceramic bearing 342 to flexibly push the ceramic bearing 342 so that the ceramic bearing 342 can stay constantly in its position for proper sealing. The elastic member 302 may comprise a spring portion 304 and a flange portion 306.

In order to rotate the drive shaft 30, the frictional fluid heating device is supplied with a power from a power source. The frictional fluid heating device may further comprise a motor so as to rotate the drive shaft 30. FIG. 2 illustrates that an electric motor 900 is used in the frictional fluid heating device. For proper operation of the frictional fluid heating device, the electric motor 900 may run at least 3500 rpm. The capacity of an electric motor to be used in the frictional fluid heating device depends on the size of discs of the disc assembly 40. The larger the diameter of a disc is the greater capacity of an electric motor is needed.

The embodiment illustrated in FIG. 1 shows that the disc assembly 40 further comprises a second-type disc 42c. The second-type disc 42c comprises a front surface 44c, a rear surface 46c, and a peripheral surface 48c. A plurality of recesses 70c are formed on the front surface 44c of the second-type disc 42c along a peripheral edge of the front surface 44c of the second-type disc 42c, and a plurality of recesses 72c are formed on the rear surface 46c of the second-type disc 42c along a peripheral edge of the rear surface 46c of the second-type disc 42c. The first-type discs 42a, 42b and the second-type disc 42c are fastened together and coaxially mounted on the drive shaft 30 so as to be rotatable together with the drive shaft 30. The first-type discs 42a, 42b and the second-type disc 42c may be fastened by bolting. In another embodiment, as illustrated in FIG. 1, a hole may be formed in the center of the second-type disc 42c and a cap 840 is installed therein to fixedly mount the disc onto the drive shaft 30.

In the embodiment of FIG. 1, the intermediate frame 120 comprises a plurality of intermediate frame parts that are a first intermediate frame part 420 and a second intermediate frame part 520. A gap formed between the outer surface 220 of the disc assembly 40 and an internal surface 212, 213, 214, and 215 of the intermediate frame 120 is approximately 0.5 mm to approximately 1 mm in width when two or three discs are used in the frictional fluid heating device to constitute the disc assembly. If more than three discs are used in the device, the gap formed between the outer surface of the disc assembly and the internal surface of the intermediate frame may need to be greater than 1 mm to provide reasonable fluid output rate.

In the embodiment of FIG. 1, the first-type discs are a rear disc 42a and an intermediate disc 42b. The elevated portion 52a and the impeller 50a of the rear disc 42a engage the rear surface 46b of the intermediate disc 42b, and the elevated portion 52b and the impeller 50b of the intermediate disc 42b engage the rear surface 46c of the second-type disc 42c.

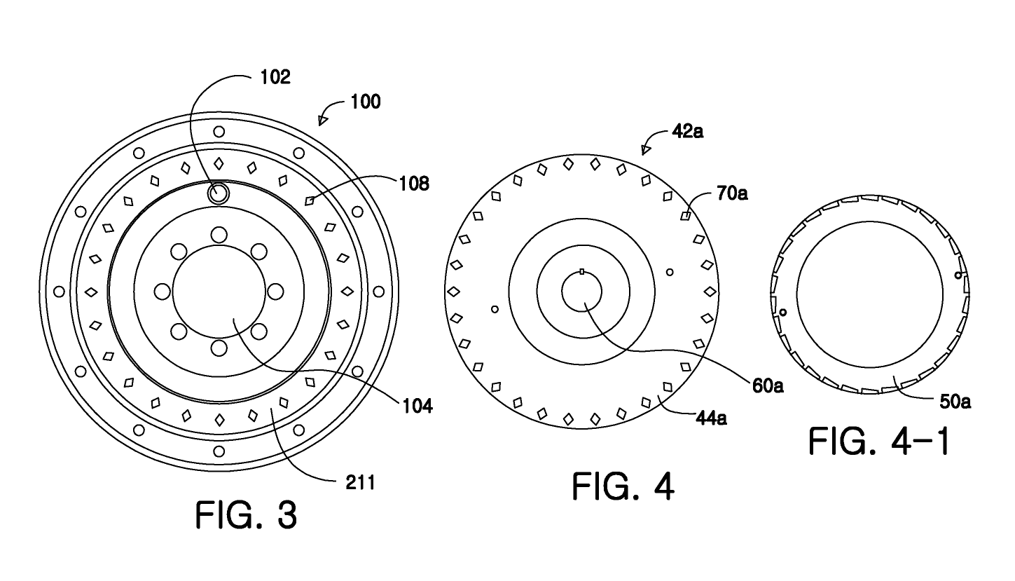

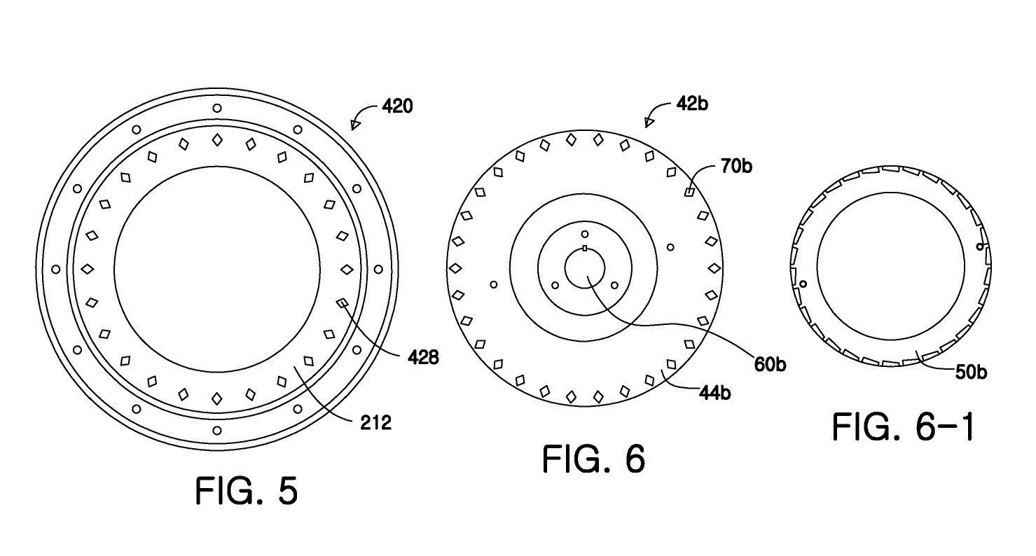

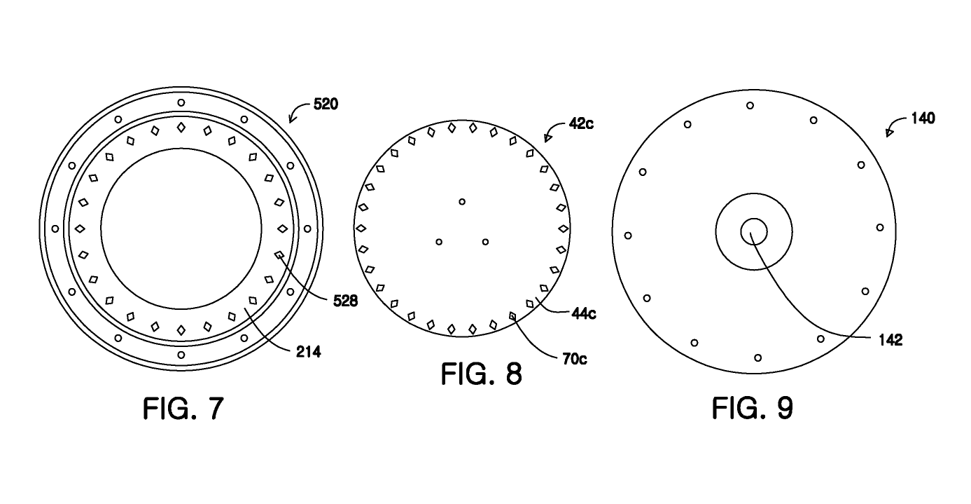

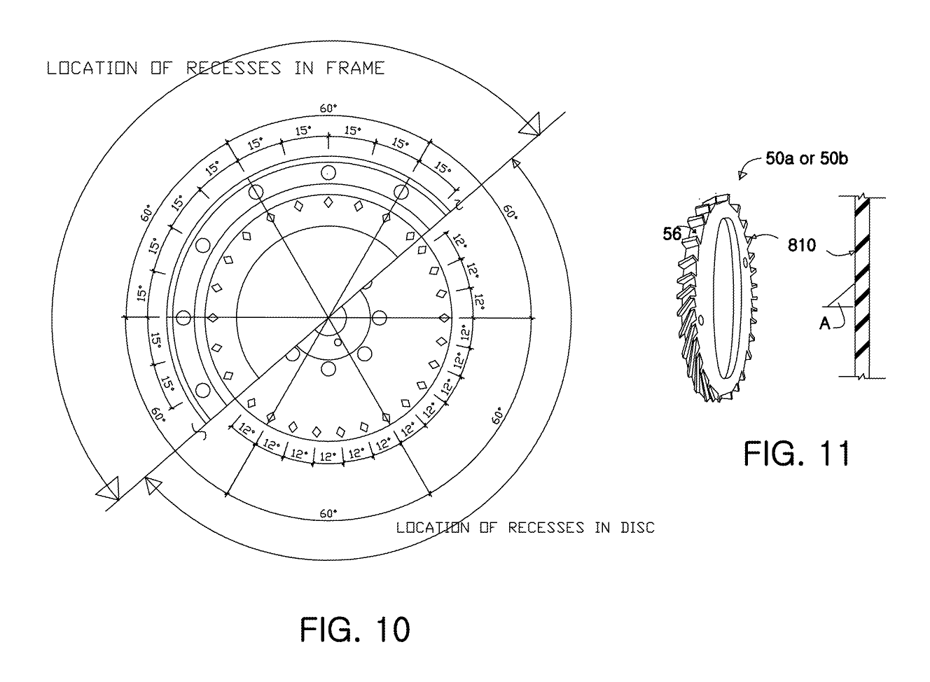

In the embodiment of FIG. 1, the internal surface of the frame assembly 50 comprises a front internal surface 211 of the rear frame 100, a rear internal surface 213 and a front internal surface 212 of the first intermediate frame part 420, a rear internal surface 215 and a front internal surface 214 of the second intermediate frame part 520, and a rear internal surface 216 of the front frame 140. The plurality of the recesses 108, 428, 438, 528, 538, 148 of the frame assembly 50 are located on the front internal surface 211 of the rear frame 100, on the front internal surface 212 and the rear internal surface 213 of the first intermediate frame part 420, on the front internal surface 214 and the rear internal surface 215 of the second intermediate frame part 520, and the rear internal surface 216 of the front frame 140. As shown in FIG. 3, the recesses 108 on the front internal surface 211 of the rear frame 100 are disposed circularly with a first diameter and are substantially uniformly spaced apart. As illustrated in FIGS. 1 and 10, the recesses 72a on the rear surface 46a of the rear disc 42a are substantially uniformly spaced apart and are disposed circularly with a diameter that is the same as the first diameter such that the recesses 72a on the rear surface 46a of the rear disc 42a face in a passing manner the recesses 108 on the front internal surface 211 of the rear frame 100 when the disc assembly 40 is rotated together with the drive shaft 30. Similarly, the recesses 438 on the rear internal surface 213 of the first intermediate frame part 420 are disposed circularly with a second diameter and are substantially uniformly spaced apart. As illustrated in FIGS. 1, 4, and 10, the recesses 70a on the front surface 44a of the rear disc 42a are substantially uniformly spaced apart and are disposed circularly with a diameter that is the same as the second diameter such that the recesses 70a on the front surface 44a of the rear disc 42a face in a passing manner the recesses 438 on the rear internal surface 213 of the first intermediate frame part 420 when the disc assembly 40 is rotated together with the drive shaft 30. Also, as shown in FIG. 5, the recesses 428 on the front internal surface 212 of the first intermediate frame part 420 are disposed circularly with a third diameter and are substantially uniformly spaced apart. The recesses 72b on the rear surface 46b of the intermediate disc 42b are substantially uniformly spaced apart and are disposed circularly with a diameter that is the same as the third diameter such that the recesses 72b on the rear surface 46b of the intermediate disc 42b face in a passing manner the recesses 428 on the front internal surface 212 of the first intermediate frame part 420 when the disc assembly 40 is rotated together with the drive shaft 30. Further, the recesses 538 on the rear internal surface 215 of the second intermediate frame part 520 are disposed circularly with a fourth diameter and are substantially uniformly spaced apart. As illustrated in FIGS. 1, 6, and 10, the recesses 70b on the front surface 44b of the intermediate disc 42b are substantially uniformly spaced apart and are disposed circularly with a diameter that is the same as the fourth diameter such that the recesses 70b on the front surface 44b of the intermediate disc 42b face in a passing manner the recesses 538 on the rear internal surface 215 of the second intermediate frame part 520 when the disc assembly 40 is rotated together with the drive shaft 30. Also, as shown in FIG. 7, the recesses 528 on the front internal surface 214 of the second intermediate frame part 520 are disposed circularly with a fifth diameter and are substantially uniformly spaced apart. As illustrated in FIGS. 1 and 10, the recesses 72c on the rear surface 46c of the second-type disc 42c are substantially uniformly spaced apart and are disposed circularly with a diameter that is the same as the fifth diameter such that the recesses 72c on the rear surface 46c of the second-type disc 42c face in a passing manner the recesses 528 on the front internal surface 214 of the second intermediate frame part 520 when the disc assembly 40 is rotated together with the drive shaft 30. Similarly, the recesses 148 on the rear internal surface 216 of the front frame 140 are disposed circularly with a sixth diameter and are substantially uniformly spaced apart. As illustrated in FIGS. 1, 8, and 10, the recesses 70c on the front surface 44c of the second-type disc 42c are substantially uniformly spaced apart and are disposed circularly with a diameter that is the same as the sixth diameter such that the recesses 70c on the front surface 44c of the second-type disc 42c face in a passing manner the recesses 148 on the rear internal surface 216 of the front frame 140 when the disc assembly 40 is rotated together with the drive shaft 30. The first diameter, the second diameter, the third diameter, the fourth diameter, the fifth diameter, and the sixth diameter may be same.

As illustrated in FIGS. 3 through 8, each of the recesses 108, 72a, 70a, 438, 428, 72b, 70b, 538, 528, 72c, 70c, 148 may be substantially diamond shape. The diamond-shape recesses 108, 72a, 70a, 438, 428, 72b, 70b, 538, 528, 72c, 70c, 148 may be arranged such that an angled point of a diamond-shape recess is directed towards an angled point of a next diamond-shape recess, as shown in FIGS. 3 through 8. The number of the recesses of the frame assembly 50 may be different from the number of the recesses of the disc assembly 40. For example, FIGS. 3 through 8 and 10 illustrate that the number of recesses on a surface of a frame may be twenty-four (24) that are uniformly spaced apart by 15° whereas the number of recesses on a surface of a disc that directly faces the surface of the frame may be thirty (30) that are uniformly spaced apart by 12°. More specifically, as an example, the number of the recesses 108 on the front internal surface 211 of the rear frame 100 may be twenty-four (24), whereas the number of the recesses 72a of the rear surface 46a of the rear disc 42a may be thirty (30). However, the number of recesses may vary depending on various factors such as the capacity of a heating device and the size of a disc or a frame.

The above structure and/or location of the recesses allow effectively heating fluid through friction and cavitation effect in a frictional fluid heating device. Such arrangement of the recesses on the frame assembly 50 and on the disc assembly 40 enhances fluid friction to eventually increase the temperature of fluid. When the disc assembly 40 rotates relative to the stationary frame assembly 50, fluid flows through a gap between the frame assembly 50 and the disc assembly 40 and reaches the recesses of the frame assembly 50 and of the disc assembly 40. Fluid molecules may vigorously move different directions in and around the recesses while the disc assembly 40 rotates, thereby producing friction. Such vigorous movements of fluid molecules, however, may hinder fluid from flowing forward in the device. To solve this problem, an impeller 50a or 50b is installed in a disc to facilitate fluid flow in the device. As a more specific example, in the embodiment shown in FIG. 1, fluid comes in the device 10 through the through hole 102 and flows in a gap between the front internal surface 211 of the rear frame 100 and the rear surface 46a of the rear disc 42a to reach the recesses 108 and 72a therein. The fluid located in and around the recesses 108 and 72a is pulled forward by the impeller 50a, which rotates together with the rear disc 42a, to continue to travel in a gap between the rear disc 42a and the first intermediate frame part 420 of the intermediate frame 120. Similarly, the impeller 50b, which rotates together with the intermediate disc 42b, pulls fluid forward to allow fluid to continue to travel in a gap between the intermediate disc 42b and the second intermediate frame part 520 of the intermediate frame 120.

The embodiment shown in FIG. 1 was tested with water as input fluid. When the temperature of the input water was 27° C., output water produced after operation of the frictional fluid heating device 10 for one (1) minute was 62° C. in temperature and 84° C. after operation of the device 10 for seven (7) minutes.

Although FIG. 1 shows an embodiment in which first-type discs 42a, 42b and a second-type disc 42c are used, only first-type discs 42a, 42b without the second-type disc 42c may be used in another embodiment. Fluid output rate of such embodiment without the second-type disc 42c may be greater than that of the embodiment shown in FIG. 1. However, the temperature of output fluid in the embodiment without the second-type disc 42c may be lower than that of the embodiment shown in FIG. 1. In still another embodiment, more number of first-type discs may be used in addition to the first-type discs 42a, 42b and more number of intermediate frame parts may be added accordingly.

The frame assembly and the discs of the disc assembly of the present invention may be made of stainless steel since stainless steel does not corrode or rust as easily as ordinary steel. In another embodiment, the frame assembly and the discs of the disc assembly of the present invention may be made of steel, which has higher thermal conductivity than stainless steel and, therefore, would increase the temperature of output fluid more than when stainless steel is used.

A method of facilitating fluid flow in a frictional fluid heating device of an embodiment of the present invention may comprise: providing a disc comprising an elevated portion, wherein the elevated portion comprises a peripheral surface; providing an impeller mounted on the peripheral surface of the elevated portion, wherein the impeller comprises grooves and gear tops that are substantially diagonally formed and are alternately located on the circumference of the impeller; and locating the disc with the impeller mounted thereon in a fluid-heating chamber of the frictional fluid heating device such that the disc with the impeller mounted thereon is rotatable together with a drive shaft. The method may further comprises providing a second disc in the fluid-heating chamber of the frictional fluid heating device, wherein the second disc comprises an elevated portion comprising a peripheral surface and an impeller is mounted on the peripheral surface of the elevated portion of the second disc. The impeller of the second disc comprises grooves and gear tops that are substantially diagonally formed and are alternately located on the circumference of the impeller of the second disc. In another embodiment, the method may further comprise providing a third disc in the fluid-heating chamber of the frictional fluid heating device, wherein the three discs are joined and rotatable together with the drive shaft.

In addition, the elements and features described above in connection with embodiments of a frictional fluid heating device may apply to embodiments of a method of facilitating fluid flow in a frictional fluid heating device of the present invention.

While the said detailed description elaborates workable embodiments of the present invention, the said embodiments shall not be construed as a limitation on the patented scope and claims of the present invention and, furthermore, all equivalent adaptations and modifications based on the technological spirit of the present invention shall remain protected within the scope and claims of the invention herein.

What is claimed is:

1. A frictional fluid heating device comprising:
a shaft fixed part;
a drive shaft supported by the shaft fixed part to be rotatable about an axis of rotation thereof;
a disc assembly comprising a plurality of first-type discs, each first-type disc comprising a front surface, a rear surface, a peripheral surface and an impeller, an opening formed at a central portion of each of the first-type discs to receive the drive shaft, an elevated portion located on the front surface of each of the first-type discs around the opening of the disc, the elevated portion having a peripheral surface, the impeller mounted on the peripheral surface of the elevated portion, the impeller comprising grooves and gear tops that are substantially diagonally formed and are alternately located on the circumference of the impeller, a plurality of recesses formed on the front surface of each of the first-type discs along a peripheral edge of the front surface of the disc, a plurality of recesses formed on the rear surface of each of the first-type discs along a peripheral edge of the rear surface of the disc; and
a frame assembly comprising a rear frame, an intermediate frame, and a front frame such that the rear frame, the intermediate frame, and the front frame are combined together, the frame assembly attached to the shaft fixed part, a through hole formed in the rear frame to receive fluid in, an opening formed at a central portion of the rear frame to receive the drive shaft, the frame assembly forming a chamber defined by an internal surface of the frame assembly, the disc assembly located within the chamber such that there is a gap formed between the internal surface of the frame assembly and an outer surface of the disc assembly to allow fluid to flow therethrough, the first-type discs coaxially mounted on the drive shaft so as to be rotatable together with the drive shaft, a through hole formed in the front frame to allow fluid to flow out therethrough, a plurality of recesses formed on the internal surface of the frame assembly such that the recesses on the first-type discs face in a passing manner the recesses of the frame assembly when the first-type discs are rotated together with the drive shaft.

2. The frictional fluid heating device of claim 1 further comprising an electric motor, wherein the drive shaft is rotatable by the electric motor.

3. The frictional fluid heating device of claim 1, wherein the drive shaft is supported by the shaft fixed part via a bearing device.

4. The frictional fluid heating device of claim 1, wherein an angle between each of the gear tops of the impeller and the axis of rotation is approximately 45° to approximately 50°.

5. The frictional fluid heating device of claim 1, wherein each of the recesses on the first-type discs is diamond shape and each of the recesses on the frame assembly is diamond shape.

6. The frictional fluid heating device of claim 5, wherein the diamond-shape recesses of the first-type discs are arranged such that an angled point of a diamond-shape recess is directed towards an angled point of a next diamond-shape recess.

7. The frictional fluid heating device of claim 5, wherein the diamond-shape recesses of the frame assembly are arranged such that an angled point of a diamond-shape recess is directed towards an angled point of a next diamond-shape recess.

8. The frictional fluid heating device of claim 1, wherein the intermediate frame comprises a plurality of intermediate frame parts.

9. The frictional fluid heating device of claim 8, wherein the disc assembly further comprises a second-type disc, the second-type disc comprising a front surface, a rear surface, and a peripheral surface, a plurality of recesses formed on the front surface of the second-type disc along a peripheral edge of the front surface of the second-type disc, a plurality of recesses formed on the rear surface of the second-type disc along a peripheral edge of the rear surface of the second-type disc, the first-type discs and the second-type disc coaxially mounted on the drive shaft so as to be rotatable together with the drive shaft.

10. The frictional fluid heating device of claim 9, wherein each of the recesses on the second-type disc is diamond shape.

11. The frictional fluid heating device of claim 9, wherein a gap formed between the outer surface of the disc assembly and an internal surface of the intermediate frame is approximately 0.5 mm to approximately 1 mm in width.

12. The frictional fluid heating device of claim 9, wherein the number of the recesses of the frame assembly is different from the number of the recesses of the disc assembly.

13. The frictional fluid heating device of claim 9, wherein the first-type discs are a rear disc and an intermediate disc, the elevated portion and the impeller of the rear disc engaging the rear surface of the intermediate disc, the elevated portion and the impeller of the intermediate disc engaging the rear surface of the second-type disc.

14. The frictional fluid heating device of claim 13, wherein the intermediate frame parts are a first intermediate frame part and a second intermediate frame part,
the internal surface of the frame assembly comprising a front internal surface of the rear frame, a rear internal surface and a front internal surface of the first intermediate frame part, a rear internal surface and a front internal surface of the second intermediate frame part, and a rear internal surface of the front frame,
the plurality of the recesses of the frame assembly located on the front internal surface of the rear frame, on the front internal surface and the rear internal surface of the first intermediate frame part, on the front internal surface and the rear internal surface of the second intermediate frame part, and the rear internal surface of the front frame,
the recesses on the front internal surface of the rear frame disposed circularly with a first diameter, the recesses on the rear surface of the rear disc disposed circularly with a diameter that is the same as the first diameter such that the recesses on the rear surface of the rear disc face in a passing manner the recesses on the front internal surface of the rear frame when the disc assembly is rotated together with the drive shaft,
the recesses on the rear internal surface of the first intermediate frame part disposed circularly with a second diameter, the recesses on the front surface of the rear disc disposed circularly with a diameter that is the same as the second diameter such that the recesses on the front surface of the rear disc face in a passing manner the recesses on the rear internal surface of the first intermediate frame part when the disc assembly is rotated together with the drive shaft,
the recesses on the front internal surface of the first intermediate frame part disposed circularly with a third diameter, the recesses on the rear surface of the intermediate disc disposed circularly with a diameter that is the same as the third diameter such that the recesses on the rear surface of the intermediate disc face in a passing manner the recesses on the front internal surface of the first intermediate frame part when the disc assembly is rotated together with the drive shaft,
the recesses on the rear internal surface of the second intermediate frame part disposed circularly with a fourth diameter, the recesses on the front surface of the intermediate disc disposed circularly with a diameter that is the same as the fourth diameter such that the recesses on the front surface of the intermediate disc face in a passing manner the recesses on the rear internal surface of the second intermediate frame part when the disc assembly is rotated together with the drive shaft,
the recesses on the front internal surface of the second intermediate frame part disposed circularly with a fifth diameter, the recesses on the rear surface of the second-type disc disposed circularly with a diameter that is the same as the fifth diameter such that the recesses on the rear surface of the second-type disc face in a passing manner the recesses on the front internal surface of the second intermediate frame part when the disc assembly is rotated together with the drive shaft,
the recesses on the rear internal surface of the front frame disposed circularly with a sixth diameter, the recesses on the front surface of the second-type disc disposed circularly with a diameter that is the same as the sixth diameter such that the recesses on the front surface of the second-type disc face in a passing manner the recesses on the rear internal surface of the front frame when the disc assembly is rotated together with the drive shaft.

15. The frictional fluid heating device of claim 14, wherein the recesses formed on the front internal surface of the rear frame are substantially uniformly spaced apart, the recesses formed on the rear surface of the rear disc are substantially uniformly spaced apart, the recesses formed on the front surface of the rear disc are substantially uniformly spaced apart, the recesses formed on the rear internal surface of the first intermediate frame part are substantially uniformly spaced apart, the recesses formed on the front internal surface of the first intermediate frame part are substantially uniformly spaced apart, the recesses formed on the rear surface of the intermediate disc are substantially uniformly spaced apart, the recesses formed on the front surface of the intermediate disc are substantially uniformly spaced apart, the recesses formed on the rear internal surface of the second intermediate frame part are substantially uniformly spaced apart, the recesses formed on the front internal surface of the second intermediate frame part are substantially uniformly spaced apart, the recesses formed on the rear surface of the second-type disc are substantially uniformly spaced apart, the recesses formed on the front surface of the second-type disc are substantially uniformly spaced apart, and the recesses formed on the rear internal surface of the front frame are substantially uniformly spaced apart.

16. The frictional fluid heating device of claim 15, wherein the number of the recesses formed on the front internal surface of the rear frame is different from the number of the recesses formed on the rear surface of the rear disc, the number of the recesses formed on the front surface of the rear disc is different from the number of the recesses formed on the rear internal surface of the first intermediate frame part, the number of the recesses formed on the front internal surface of the first intermediate frame part is different from the number of the recesses formed on the rear surface of the intermediate disc, the number of the recesses formed on the front surface of the intermediate disc is different from the number of the recesses formed on the rear internal surface of the second intermediate frame part, the number of the recesses formed on the front internal surface of the second intermediate frame part is different from the number of the recesses formed on the rear surface of the second-type disc, and the number of the recesses formed on the front surface of the second-type disc is different from the number of the recesses formed on the rear internal surface of the front frame.

17. The frictional fluid heating device of claim 14, wherein each of the recesses formed on the front internal surface of the rear frame, on the rear surface of the rear disc, on the front surface of the rear disc, on the rear internal surface of the first intermediate frame part, on the front internal surface of the first intermediate frame part, on the rear surface of the intermediate disc, on the front surface of the intermediate disc, on the rear internal surface of the second intermediate frame part, on the front internal surface of the second intermediate frame part, on the rear surface of the second-type disc, on the front surface of the second-type disc, and on the rear internal surface of the front frame is diamond shape.

18. The frictional fluid heating device of claim 1, wherein the grooves of the impeller are substantially uniformly spaced apart.

19. A method of facilitating fluid flow in a frictional fluid heating device, the method comprising:
providing a disc comprising an elevated portion, the elevated portion comprising a peripheral surface;
providing an impeller mounted on the peripheral surface of the elevated portion, the impeller comprising grooves and gear tops that are substantially diagonally formed and are alternately located on the circumference of the impeller; and
locating the disc with the impeller mounted thereon in a fluid-heating chamber of the frictional fluid heating device such that the disc with the impeller mounted thereon is rotatable together with a drive shaft.

20. The method of claim 19 further comprising providing a second disc in the fluid-heating chamber of the frictional fluid heating device, wherein the second disc comprises an elevated portion comprising a peripheral surface and an impeller is mounted on the peripheral surface of the elevated portion of the second disc, the impeller of the second disc comprising grooves and gear tops that are substantially diagonally formed and are alternately located on the circumference of the impeller of the second disc.
